(19) United States
(12) Patent Application Publication
(10) Pub. No.: US 2013/0344469 A1
(43) Pub. Date: Dec. 26, 2013

(54) Open Paradigm for Interactive Networked Educational Systems

(71) Applicant: Texas Instruments Incorporated, Dallas, TX (US)

(72) Inventors: Albert Louis Abrahamson, Yorktown, VA (US); Corey Brady, Wilmette, IL (US); Robert C.W. Jenks, McKinney, TX (US); Mark Dennis Fry, Chicago, IL (US); Todd M. Wostrel, Crossroads, TX (US)

(21) Appl. No.: 13/926,588

(22) Filed: Jun. 25, 2013

Related U.S. Application Data
(60) Provisional application No. 61/663,884, filed on Jun. 25, 2012.

(51) Int. Cl. G09B 5/00

(52) U.S. Cl. CPC G09B 5/00
USPC 434/350

(57) ABSTRACT

An interactive networked classroom system including a teacher workstation with a base application, and one or more code segments. Each code segment includes a teacher version and a student version. The code segments include API links to a base application at the teacher workstation, or to helper functions such as plug-ins to the base application, such that the student version of the code segment has different rights, typically fewer and less powerful rights, than the teacher version of the same code segment. The teacher workstation forwards the student version of a code segment to student workstations that are in communication with the teacher workstation over a network facility; the student code segments may be embedded in a document corresponding to a classroom activity. Interactive classroom activities are then carried out using the code segments in combination with the base application. The use of scripting language (or applets) enables education personnel to create new educational contexts without requiring alteration of the base application code.

### CROSS-REFERENCE TO RELATED APPLICATIONS

This application claims priority, under 35 U.S.C. §119(e), of Provisional Application No. 61/663,884, filed Jun. 25, 2012, incorporated herein by this reference.

### STATEMENT REGARDING FEDERALLY SPONSORED RESEARCH OR DEVELOPMENT

Not applicable.

### BACKGROUND OF THE INVENTION

This invention is in the field of interactive operation of networked computer systems. Embodiments of this invention are more specifically directed to networked educational systems as used in a classroom context.

Advances in computing and communications technology have begun to change the nature of educational tools and techniques, including in the classroom environment. Modern high-performance handheld portable computing devices, such as modern programmable graphing calculators, tablet computers, and smartphones, provide students with the ability to visualize and solve complex problems, and encourage the development of technical skills. The benefits of these powerful devices in the hands of students can be even further enhanced when deployed in a networked environment, such as over a wireless classroom network, which facilitates communication between the students and the instructor, among themselves, and over a wide area network such as the Internet. Advanced networked classroom environments have also opened the way for a wide variety of motivating and engaging learning activities, such as learning games, competitions, simulations, participatory simulations, and interactive collaborations.

Networked educational systems that take advantage of these benefits are known in the art. One example is the TI-NSPIRE NAVIGATOR system, available from Texas Instruments Incorporated, in which a laptop or personal computer used by a classroom teacher interactively communicates with student handheld graphing calculators, such as the TI-NSPIRE CX and CX CAS handhelds available from Texas Instruments Incorporated. This system provides interactive communication and file transmission of assignments and results between teacher and student, enables the teacher to instantly assess and record student progress, enhances teacher lectures and presentations with content displayed at the student handhelds, facilitates group work on the part of the students, and the like.

Conventional networked educational systems typically provide the functions of presenting questions and problems to be solved by the students, and of gathering, aggregating, and displaying student responses to those questions and problems. Simple systems are referred to in the art as “clicker-type” systems, in which the students are presented with multiple choice or numeric answers to the questions or problems, to which the students respond by selecting one of the presented answers. More advanced systems utilize student handheld devices such as graphing calculators, tablet computers, and smartphones. Regardless of the devices used by the students, these conventional systems enable the teacher to gather and aggregate the answers received from the students at her computer, from which the teacher can review the progress of individual students, and that of the class as a whole. The aggregated information can also be used to determine the next lessons to be presented by the teacher, for example by indicating that a concept ought to be reinforced by instruction or additional student work if much of the class performed poorly regarding a particular concept.

In these and other conventional networked classroom systems, the applications and software architecture are arranged by the software system manufacturer. More specifically, conventional educational software packages for networked classroom systems operates in a highly structured fashion within a fixed number of “paradigms”, in that the application itself specifies and enforces certain contexts that define the types and nature of the interactive operations between the teacher and the students in carrying out the lessons. Some currently available packages provide the teacher with some level of flexibility in controlling the way in which the interactive lesson is carried out, for example by selecting pre-defined options by way of a pull-down menu or configuration tab. However, the ability of the teacher or other education professional to design a new interactive context for presenting content and enabling hands-on student practice and assessment is very limited in these conventional packages. Modification of the software to implement a new educational context necessarily involves technical personnel at the software system manufacturer, as such changes require modification to the base code in those conventional packages.

Conventional networked educational systems also present other limitations. Because of the structured paradigms of existing educational software packages, a class may be called upon to use more than one software package during the school term, or even during the class period. Typical educational packages require the students (as well as the teacher) to log in upon entry into the package, enabling proper recording of the student's performance. But in order for a student to switch from one package to another, it is necessary for each student to log out of one package and log in to another package. Not only is this operation cumbersome and error-prone, but the resulting separation of software packages is a barrier to coherent individual and class-wide record-keeping. This issue is exacerbated if some students in the class are working in one package while others are working in another package.

### BRIEF SUMMARY OF THE INVENTION

Embodiments of this invention provide an interactive educational system and method of operating the same that facilitates the implementation of new educational contexts by its users.

Embodiments of this invention provide such a system and method that enables such new educational contexts while maintaining the security of the underlying system and base application code.

Embodiments of this invention provide such a system and method that simplifies the distribution, delivery, and installation of new applications within the context of the existing networked classroom system.

Embodiments of this invention provide such a system and method that enables teacher-student interaction, and interaction among students, in a manner that is more focused to the individualized needs of the student, as determined by performance on classroom activities, including competitions, games, and simulations, whether carried out by students individually or as collaborations among students in pairs, small groups, in larger class segments, or even among entire classes via a wide-area network.

Other objects and advantages of embodiments of this invention will be apparent to those of ordinary skill in the art having reference to the following specification together with its drawings.

Embodiments of this invention may be implemented into a networked educational system and method of operating the same according to a software architecture in which a base application is executed at a teacher workstation. The system also includes student workstations that are in communication with the teacher workstation, for example by way of a wireless network. A library of code segments are available to the teacher workstation, each code segment having teacher and student versions that are capable of operating cooperatively with one another, but that have different levels of rights. For example, application programming interfaces (APIs) in the student version of the code segment may enable fewer and less-powerful input/output or data access privileges than the APIs of the corresponding teacher version of the code segment.

In operation, the teacher workstation initiates an activity by invoking a teacher code segment at the teacher workstation; this teacher code segment opens communication “sockets” with the base application and its functions, and with the student workstations. The teacher workstation also forwards student versions of the code segment corresponding to the invoked teacher to one or more student workstations. The student version of the code segment may be embedded in a document including questions, problems, or activities to be worked by the student. The student version of the code segment includes API links (or SDK facilities) that enable the student workstation to transmit responses and other communications to the main application or to the teacher version of the code segment. The corresponding teacher code segment interfaces with functions of the main application to view, aggregate, record, or otherwise evaluate student responses transmitted by the corresponding student code segments. Additional functions may be carried out by the teacher code segment, including managing inter-student communications, grouping subsets of students in the class, assigning problems to subsets of the students, allowing student access to helper functions of the main application, and the like.

Embodiments of this invention provide the teacher and other educational personnel with the ability to program and implement new student activities and classroom contexts by way of the paired code segment, taking advantage of the relatively simple APIs or SDKs used to implement those code segments, for example as may be employed via scripting languages available for such functions. The use of code segments eliminates the need for the software or system manufacturer to rewrite base code to implement a new context, thus broadening and democratizing the development of these new educational contexts for the networked system. These new activities and contexts can be safely and reliably implemented in systems according to embodiments of the invention, as non-activity-specific functions (e.g., plug-ins or in the base application or “app” itself) can remain unaltered.

### BRIEF DESCRIPTION OF THE SEVERAL VIEWS OF THE DRAWING

FIG. 1 is a system diagram, in block form, of a networked educational system as deployed in a classroom environment according to embodiments of this invention.

FIG. 2 is an electrical diagram, in block form, of teacher and student workstations constructed according to embodiments of this invention.

FIGS. 3a, 3b, and 3c are block diagrams of the software architecture as installed at a teacher workstation before and after configuration of code segments in the form of scripts, and after startup, respectively, according to embodiments of this invention.

FIG. 3d is a system diagram of a networked educational system with an educational activity deployed to workstations in the classroom environment of FIG. 1, according to an embodiment of this invention.

FIG. 4 is a flow diagram illustrating the operation of the networked educational system according to FIGS. 3a through 3d initiating an interactive classroom activity, according to an embodiment of the invention.

FIG. 5 is a flow diagram illustrating the operation of the networked educational system according to FIGS. 3a through 3d carrying out an interactive classroom activity in which a class is segmented by way of a teacher version of a code segment into a plurality of “combos”, according to an embodiment of the invention.

FIGS. 6a through 6d are views of a graphics display at a teacher workstation in performing the interactive classroom activity of FIG. 5, according to that embodiment of the invention.

FIG. 7 is a flow diagram illustrating an example of the interactive cooperation between students in the classroom activity of FIGS. 5 and 6a through 6d, according to an embodiment of the invention.

FIG. 8 is a view of the graphics display at a teacher workstation in analyzing the results of the classroom activity of FIG. 7, according to that embodiment of the invention.

FIG. 9a is a system diagram of a networked educational system with an educational activity deployed to workstations in the classroom environment of FIG. 1, according to another embodiment of this invention.

FIG. 9b is a flow diagram illustrating the operation of the networked educational system according to FIG. 9a in initiating an interactive classroom activity, according to that embodiment of the invention.

FIG. 10 is a system diagram of a networked educational system with an educational activity deployed to workstations in the classroom environment of FIG. 1, according to another embodiment of this invention.

### DETAILED DESCRIPTION OF THE INVENTION

This invention will be described in connection with its embodiments, namely as implemented into a networked computer system for a classroom environment, as it is contemplated that the invention is especially beneficial when used in such an environment. It is further contemplated, however, that the invention may also provide significant benefit in other interactive networked environments. Accordingly, it is to be understood that the following description is provided by way of example only, and is not intended to limit the true scope of this invention as claimed.

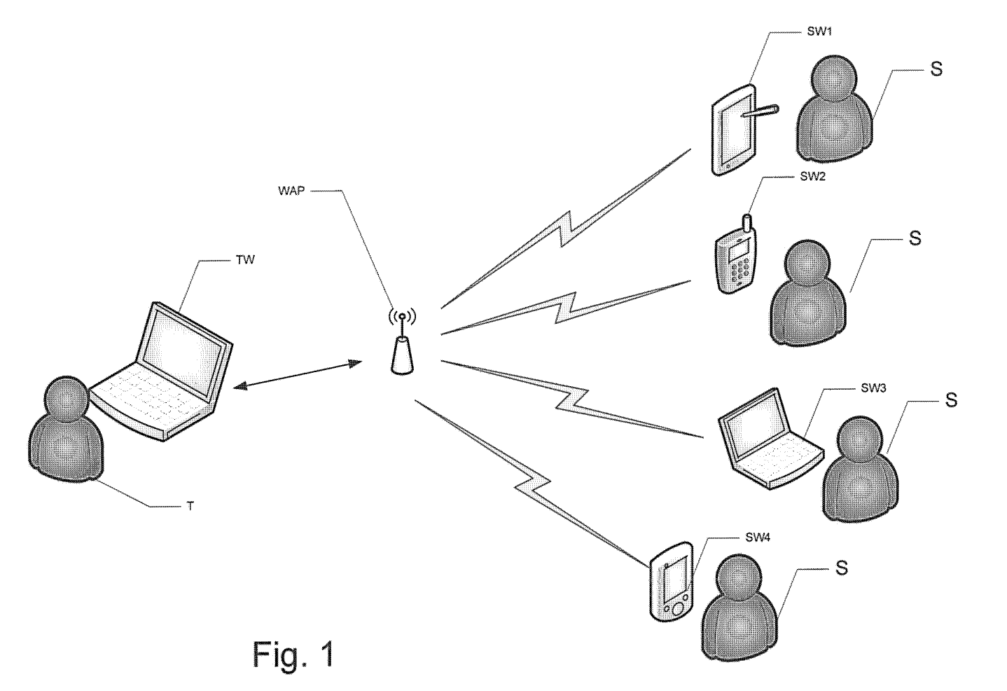

As noted above, embodiments of this invention are contemplated to be beneficial when deployed into a classroom environment. An example of such an environment is shown in FIG. 1, which illustrates a classroom context into which an embodiment of the invention is deployed. In this example, teacher T is at teacher workstation TW, and is managing a classroom activity being performed by one or more students S, each at a corresponding student workstation SW1 through SW4. In this example, communication between teacher workstation TW and student workstations SW (referring generically to student workstations SW1 through SW4) is carried out by way of a network facility in the form of a wireless local area network via wireless access point WAP. As will be evident from the following description, communication among student workstations SW will be managed by teacher workstation TW, according to a hub-and-spoke architecture.

It is contemplated that the context of FIG. 1 can be implemented in many and varied forms. In this regard, for purposes of this description, the term “workstation” is not intended to refer to a specific class of computer system, but is instead intended to refer generically to an electronic device or system of any one of a number of types and classes as suitable for use by the teacher or a student, as the case may be, for carrying out the functions described herein in the classroom environment of FIG. 1. For example, while teacher workstation TW is shown as a laptop personal computer, it may alternatively be implemented as a dedicated device for this classroom function, a general purpose desktop computer, a client terminal in a larger-scale client-server classroom computing system, a tablet computer or other portable handheld device, or any other device or system of sufficient computational capacity to carry out the functions described herein. Similarly, FIG. 1 shows various forms of student workstations SW, including student workstation SW1 as a tablet computer, student workstation SW2 as a smartphone, student workstation SW3 as a laptop computer, and student workstation SW4 as a graphing calculator. Other implementations of student workstations SW are also contemplated, specifically any other device or system of sufficient computational capacity to carry out the functions described herein. Furthermore, the network facility among workstations TW, SW may be implemented in various ways, including a wired and wireless local area networks, or a combination of wireless and wired local area networks, or even remote classroom environments in which one or more of student workstations SW are remote from the physical classroom, and communicate with teacher workstation TW over a wide area network such as the Internet.

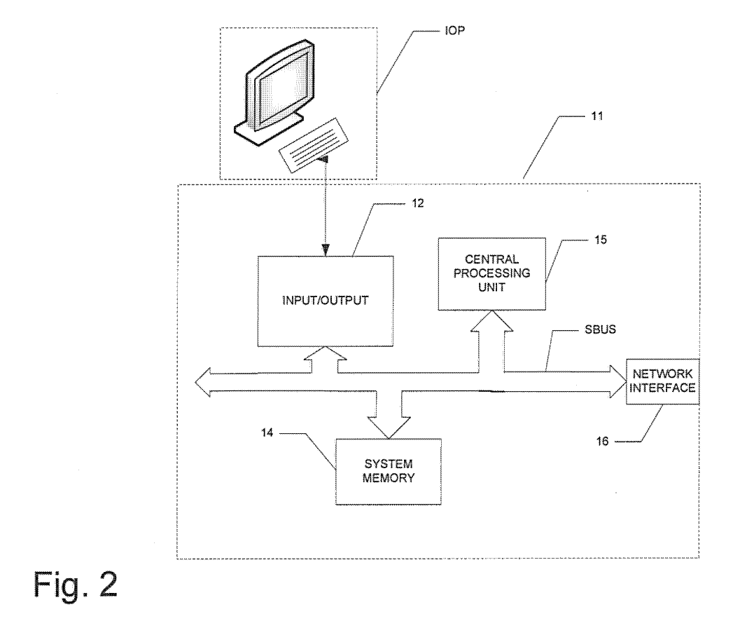

FIG. 2 illustrates the construction of workstation 11 according to an example of a generic architecture as suitable for realizing any of teacher workstation TW and student workstations SW. It is to be understood that this particular workstation architecture is not essential to embodiments of this invention, and that other architectures may alternatively be used; the example of FIG. 2 is provided by way of example only, to provide context to this description. Workstation 11 includes central processing unit 15, coupled to system bus SBUS. Also coupled to system bus SBUS is input/output interface 12, which refers to those interface resources by way of which peripheral functions I/O (e.g., keyboard, mouse, display, touchscreen, etc.) interface with the other constituents of workstation 11. Network interface 16 is a conventional interface or adapter, also coupled to system bus SBUS, by way of which workstation 11 accesses the network facility, e.g. the wireless network among teacher workstation TW and student workstations SW in FIG. 1.

Central processing unit 15 refers to the data processing capability of workstation 11, and as such may be implemented by one or more CPU cores, co-processing circuitry, and the like. The particular construction and capability of central processing unit 15 is selected according to the application needs of workstation 11, such needs including, at a minimum, the carrying out of the functions described in this specification. In this example, system memory 14 is coupled to system bus SBUS, and provides memory resources of the desired type useful as data memory for storing input data and the results of processing executed by central processing unit 15, as well as program memory for storing the computer instructions to be executed by central processing unit 15 in carrying out those functions. Of course, this memory arrangement is only an example, it being understood that system memory 14 can implement such data memory and program memory in separate physical memory resources, or distributed in whole or in part outside of workstation 11.

According to this embodiment of the invention, by way of example, program memory resource within system memory 14 stores computer instructions executable by central processing unit 15 to carry out the functions described in this specification, by way of which interactive classroom activities are carried out in the environment of FIG. 1. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions for creating the model according to embodiments of this invention may be written in a conventional high level language such as JAVA, C++, or the like, either as a conventional linear or procedural computer program, or arranged for execution in an object-oriented manner. These instructions may also be embedded within a higher-level application, or alternatively may be in the form of an executable web-based application that is accessible to server 30 and client computer systems such as workstation 11 for receiving inputs from the client system, executing algorithms modules at a web server, and providing output to the client system. In any case, it is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed into workstation 11 in the conventional manner for software installation.

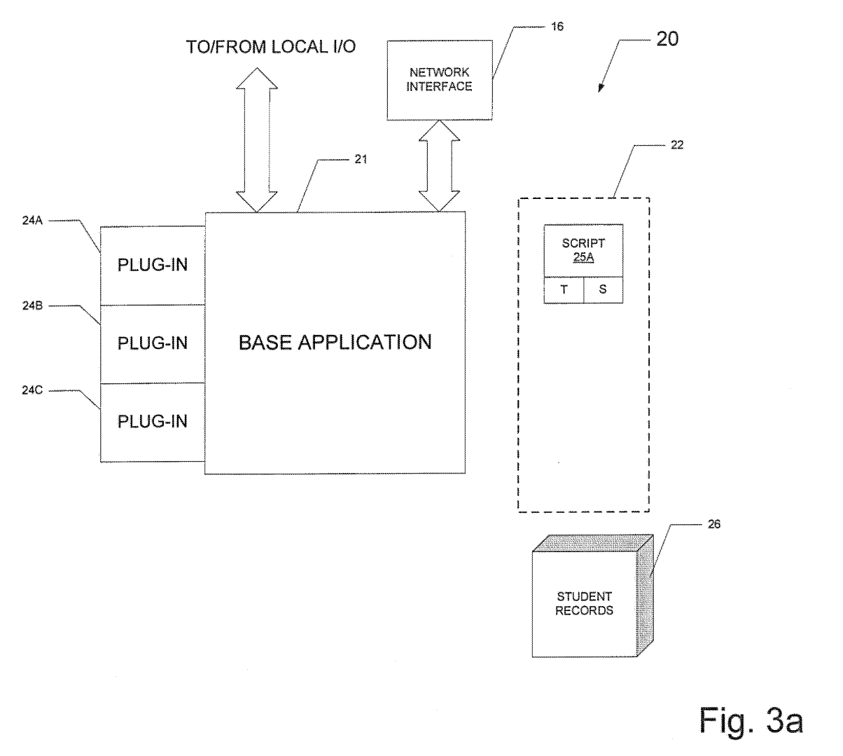

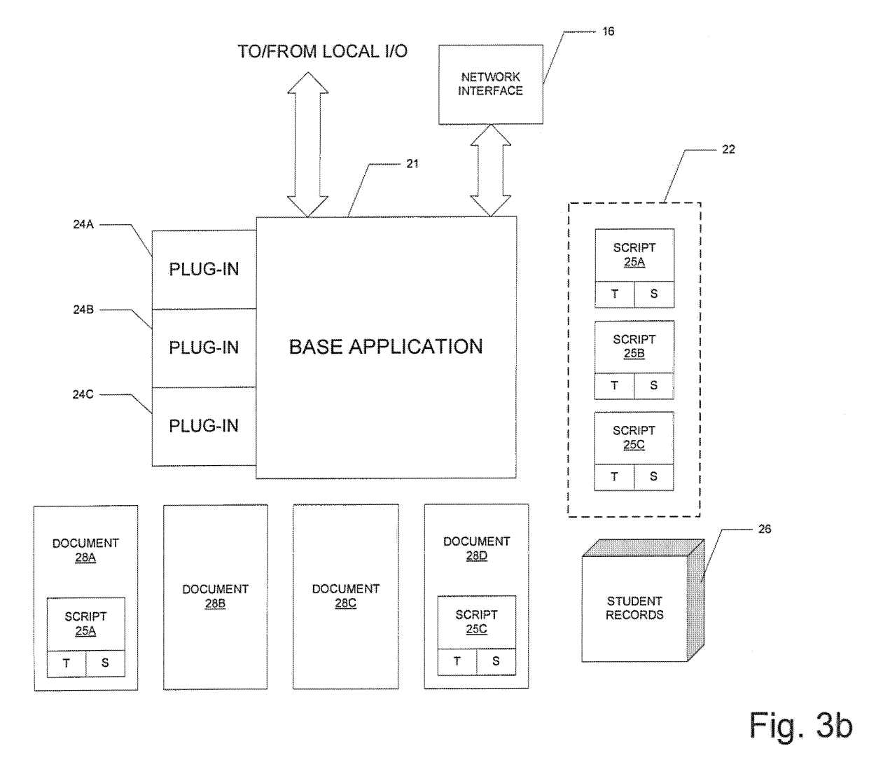

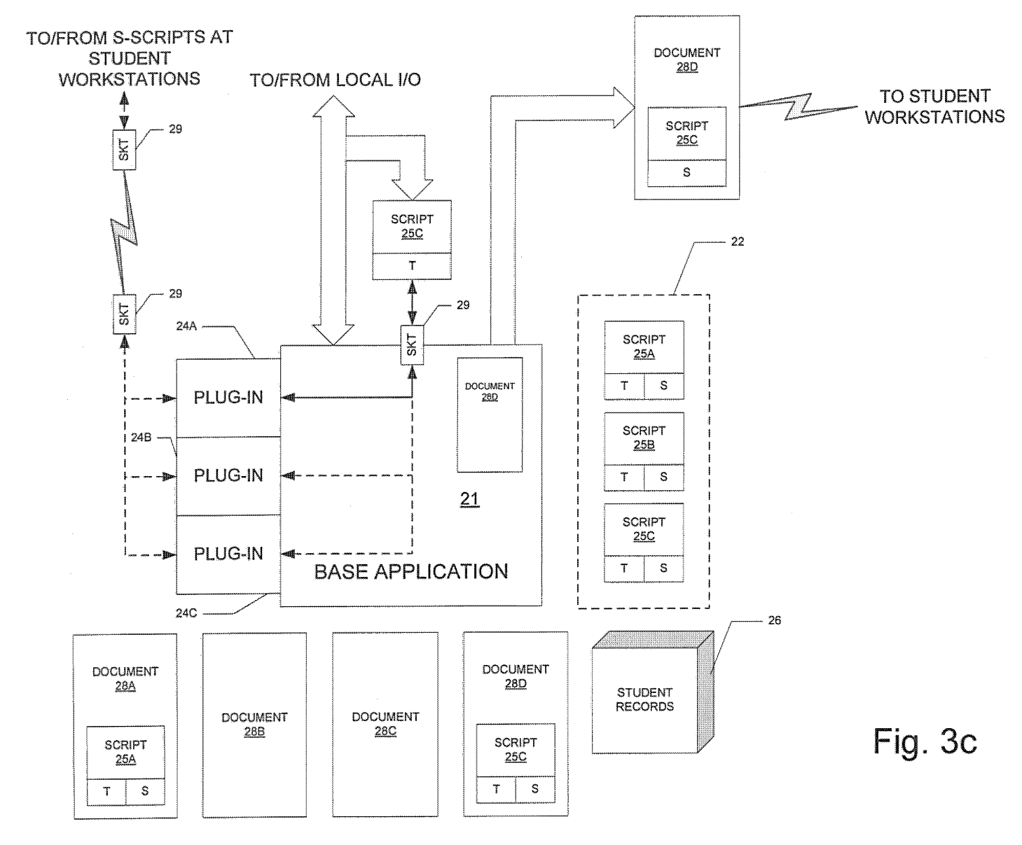

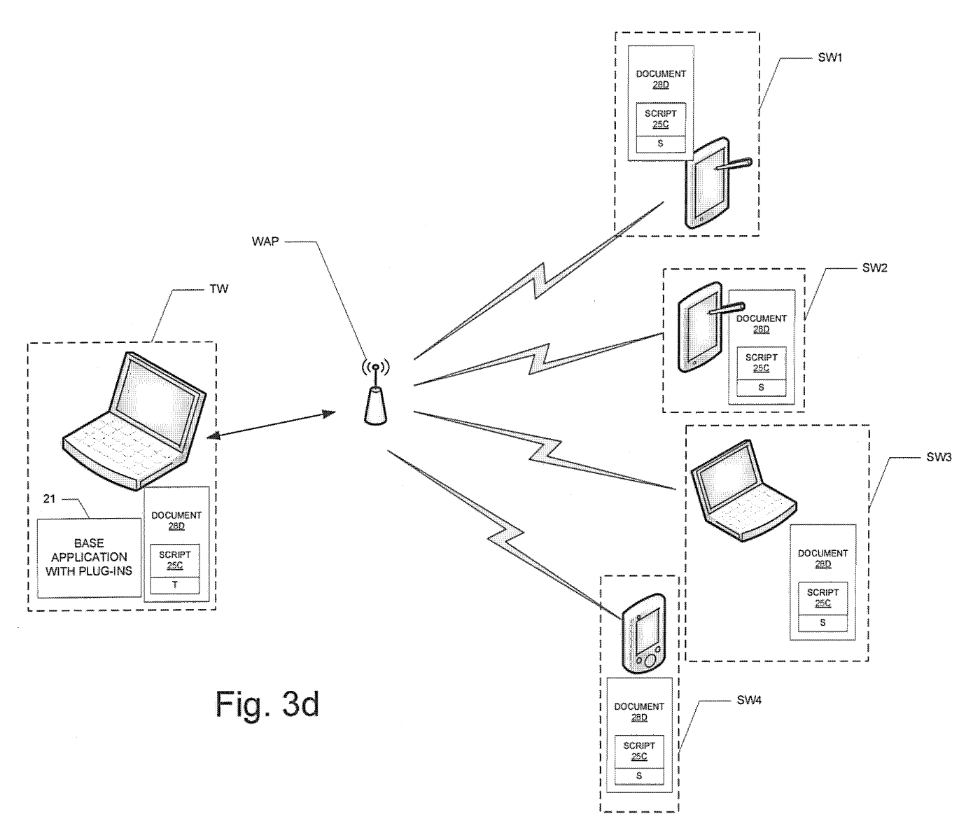

An example of the architecture of the software installed at and executed by teacher workstation TW in carrying out interactive classroom activities in cooperation with student workstations SW, according to embodiments of this invention, will now be described relative to FIGS. 3a through 3d.

As will be described in further detail below, it is contemplated that the software architecture of embodiments of this invention will be especially beneficial in enabling teachers and other educational professionals to easily and efficiently implement new classroom activities and “contexts” (i.e., interaction processes among students and the teacher, such as those involved in delivering individualized classwork and assistance to students according to their individual progress in grasping concepts), without requiring modification of the underlying programming code of the overall system. As such, a feature of the software installed at teacher workstation TW is its ability to accept new activities and procedures, in addition to those developed by the system manufacturer and originally installed. In this regard, FIG. 3a illustrates an example of the architecture of interactive classroom software package 20, as may be initially installed at teacher workstation TW. According to the description above, the constituents of installed software package 20 are contemplated to be stored within system memory 14, at a physical memory resource within or otherwise accessible to workstation TW.

As shown in FIG. 3a, software package 20 includes base application 21. Base application 21 refers to program instructions executable by processor 15 of teacher workstation TW to perform operations useful to the teacher in delivering instructional material and corresponding classwork in the classroom environment. Base application 21 may correspond to the operating system of teacher workstation TW, or an application program invoked and executing in cooperation with the operating system, or a “shell” installed under the operating system within which these functions are carried out. In any case, it is contemplated that base application 21 implement such educational functions as a tool for creating questions and problems to be solved by the student; a workspace function enabling the teacher to access online and locally stored files, including pre-authored content; tools for creating and displaying lecture presentation material including displaying step-by-step procedures for problem solving as performed by the teacher; interactive mathematical tools such as graphing, calculating, equation editing, and the like; interactive geometry tools; and others. These and other functions of base application 21 are similar to those implemented in conventional base application software packages are the TI-NSPIRE, TI-NSPIRE CAS, TI-NSPIRE NAVIGATOR, and TI-NSPIRE CAS NAVIGATOR teacher software packages available from Texas Instruments. Base application 21 also includes the appropriate drivers for communicating with local input and output functions (i.e., touchscreen, keyboard, mouse, graphics display, audio output, etc.), and for communicating with other computers via network interface 16 and the corresponding network facility.

According to embodiments of this invention, however, base application 21 operates in cooperation with “helper functions” that provide data collection, data aggregation, communication, and other operations described herein. It is contemplated that these helper functions can structure and control the display of information at teacher workstation TW, can access student information and responses, and can provide teacher T with real-time control of the overall interactive networked system for the classroom. Some helper functions may execute data processing operations on student data, for example aggregation and analysis. In this architecture, these helper functions are “global”, within the context of software package 20, in the sense that their functions are not specific to an individual classroom activity, but rather will be useful over a wide range of classroom activities. In addition, as will be described in further detail below, these helper functions as executed at teacher workstation TW are capable of communicating data to and from student workstations SW by way of “sockets” that are provided to “scripts” running on those workstations.

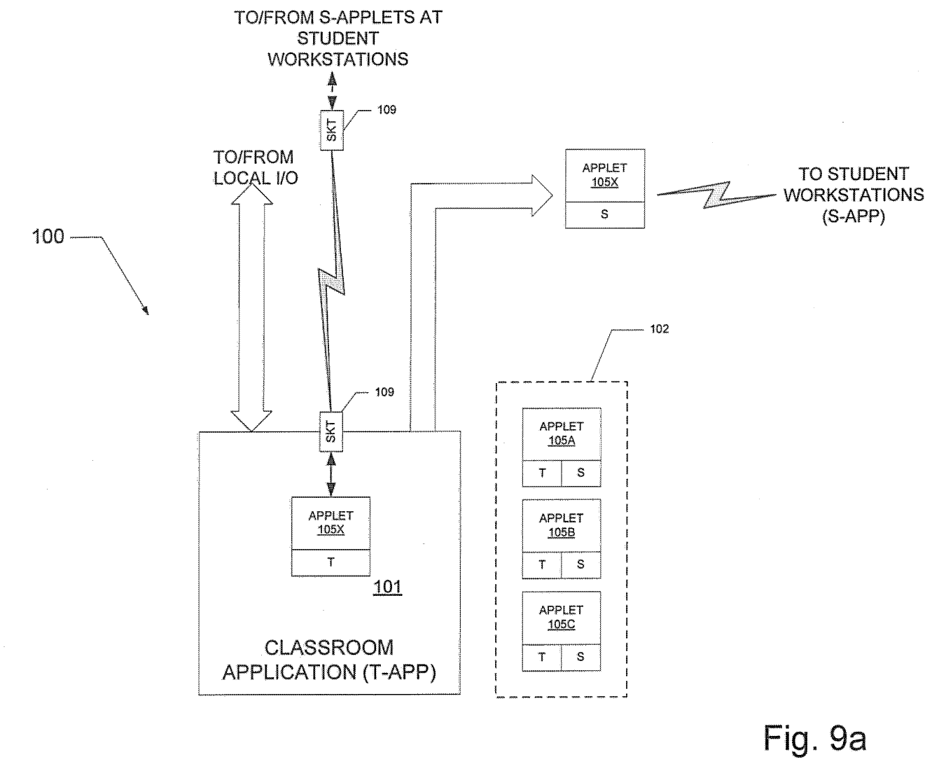

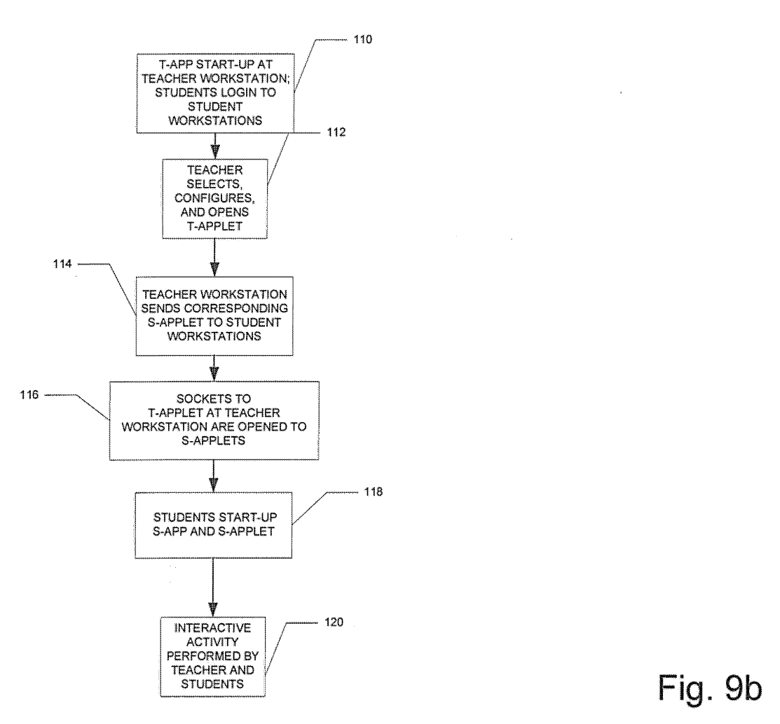

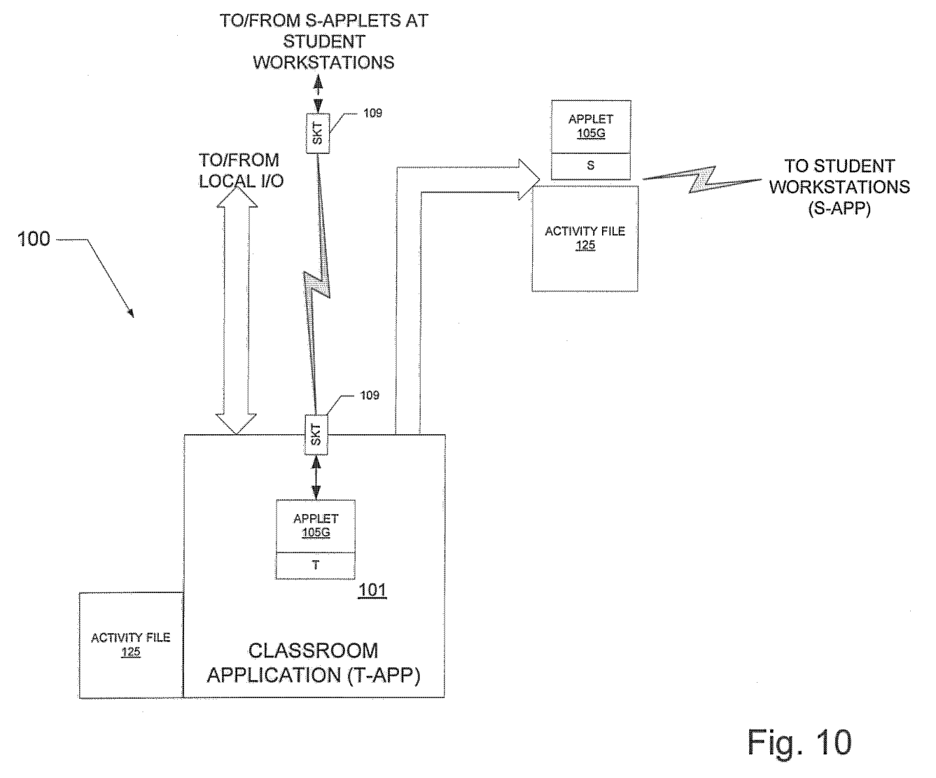

In the example of software package 20 shown in FIG. 3a, helper functions are implemented in the form of plug-ins 24A, 24B, 24C to base application 21. As known in the art, plug-ins are special purpose software programs or applications that are callable by another application (e.g., such as a movie viewer that can be called by a web browser). As such, plug-ins 24 provide a convenient form for implementing helper functions in this architecture, and as such this description will refer to helper functions in the form of plug-ins 24. Alternatively, however, program instructions within base application 21, for example in the form of subroutines and the like, may implement helper functions, according to embodiments of this invention. Additional alternative realizations of helper functions in alternative software architectures will be described below in connection with FIGS. 9a, 9b, and 10.

Base application 21 also includes the appropriate capability, whether directly or by way of a helper function such as one of plug-ins 24, for reading data from and writing data to student record database 28. Student record database 28 may reside in one of the memory resources of teacher workstation TW (i.e., within system memory 14), or may reside in a memory resource elsewhere in the network, and accessible to teacher workstation TW via network interface 16.

According to embodiments of the invention, an interactive networked classroom system is realized according to a software architecture in which “code segments” can control and automate the communication of data and messages in connection with classroom activities. More specifically, it is contemplated that these code segments are relatively simple executable computer programs that can be written and modified by a wide range of users and personnel, without requiring a high level of programming knowledge or experience, and without necessitating involvement of the system manufacturer to modify base application 21 or to verify the particular code segments. According to embodiments of this invention, various types of executable programs can be used to realize these code segments, such as scripts, applets, routines and subroutines, servlets, code units or other sub-programs, plug-ins, procedures, or functions, or combinations thereof. Additionally, it is anticipated that associated components appropriate or necessary for the loading and execution of these code segments, such components including pre-processors, interpreters, compilers, linkers, loaders, dynamic linkers, dynamic linkers with late bindings, and the like as known by those skilled in the art having reference to this specification, will be provided by the system manufacturer.

In this regard, it is contemplated that these code segments will generally be activity-specific, in that each instance will be written and associated with a particular classroom activity, such as a problem set, quiz, lecture with interactive student responses, competition, game, collaborative activity, participatory simulation, and the like. It is to be understood that the same code segment may be used repeatedly for the same activity as applied to different content; for example, a quiz code segment may used for multiple quizzes involving different questions. This specificity of code segments to individual activities facilitates the simplicity of the programming involved. As such, it is contemplated that teacher T, another educational professional, members of a “users' group”, or another user of software package 20 will generate some if not all of these code segments.

In the embodiment of the invention shown by way of the software architecture of FIG. 3a, these code segments will be realized in the form of “scripts”. As known in the art, the term “script” refers to an executable computer program written for a runtime environment, typically as a simple program for interpreting and automating the execution of certain tasks, such as a sequence of steps taken by a human user of the computer. Scripts are generally written in a “scripting language”, examples of which include JCL, Perl, LUA, JavaScript, and “macros” generated via graphical user interface (GUI) user commands. These scripting languages are typically interpreted rather than compiled, as known in the art. Scripts may be embedded within a text file, or in other types of documents, as will become apparent from this description.

In the architecture of software package according to this embodiment of the invention, software package 20 includes a code segment library, in the form of user script pool 22, that contains one or more scripts 25 that carry out particular functions in the operation of the interactive educational system as will be described in detail below. In its form as initially installed at teacher workstation TW as shown in FIG. 3a, user script pool 22 includes script 25A, which was written and installed by the system manufacturer. According to this embodiment of this invention, scripts 25 carry out communication between student workstations SW and teacher workstation TW and helper functions (i.e., plug-ins 24) of base application 21. As such, scripts 25 include application programming interfaces (APIs) that provide that communication functionality. As known in the art, APIs are specifications regarding functions to be executed. In this embodiment of the invention, plug-ins 24A, 24B, 24C each have a defined API, i.e. a set of input/output specifications, by way of which data and messages can be communicated thereto and therefrom, and also by way of which the execution of operations by plug-ins 24 can be controlled. Plug-ins 24A, 24B, 24C may support some or all of the same APIs, or may have different APIs, depending on their respective operations.

As known in the art, an executable program can utilize the APIs of an operating system or another application program by including, in its own program instructions, links referring to those APIs. In a procedural language, these API links are inserted into the executable program by “include” statements or the like specifying those functions; in an object-oriented language, class definitions and their corresponding inheritances are used to insert the API links into the executable program. In embodiments of this invention, scripts 25 are constructed to include APIs links to those plug-ins 24 that are to be utilized during classroom activities. As a result, in embodiments of this invention, scripts 25 will provide communication conduits, in the software sense, between student workstations SW and teacher workstation TW during classroom activities.

According to embodiments of this invention, however, scripts 25 include links to only a subset of the APIs supported by plug-ins 24; the API links that are included within an instance of script 25 thus amount to the “rights” granted to the workstation executing that script. In embodiments of this invention, scripts 25 in user script pool 22 are “paired” scripts, in the sense that each script 25 has a teacher script version (shown with a “T” indicator) and a student script version (shown with an “S” indicator), with different API links included in its student version than in its teacher version. Script 25A resides in user script pool 22 of FIG. 3a in both of its teacher and student versions). In particular, the subset of API links included in the student version of script 25 will be smaller than the subset of API links included in the associated teacher version of that same script 25; this difference in the included API links differentiates the rights granted to student workstations SW relative to software package 20, from those available to teacher workstation TW. For example, the API links included in the teacher version of script 25 (referred to herein as “T-script” 25) may permit teacher T to add to or modify menu items of base application 21, activate “sockets” or communication ports into plug-ins 24, modify graphical representations generated by plug-ins 24, and the like, while the corresponding student version (referred to herein as “S-script”) is not permitted to execute these operations. An example of the difference in API capabilities between the teacher and student versions of script 25, according to an embodiment of the invention, is summarized in the following table:

| | Teacher Version API Capabilities | Student Version API Capabilities |
|---|---|---|
| Data | Access to student roles, groups, | Access login information for |
| | segmentation or combos, for | this student computer only; |
| | current class; | Access to description of |
| | Access to current login | current activity including |
| | information for current class; | documents, files, and |
| | Access to student records and | temporary transient data |
| | performance/achievement data | transmitted over the |
| | on past activities and tests; | network; |
| | Access to complete information on | Access to group information |
| | current activities including all | applicable to this activity for |
| | student work submitted, and | this computer; |
| | aggregations and sortings of the | Access to selected information |
| | same. | (e.g. aggregation) from |
| | | partner, class, group, |
| | | segment, or combo. |
| Controls | Open and close student login, class | Work on activity; |
| | segmentation, combos, | Pass on work or message to |
| | grouping, or other permissions; | partner, others in small |
| | Set permissions for messaging | group, combos, or class |
| | between students, groups, | segments; |
| | combos, or segments; | Send work to teacher, message |
| | Set permissions for students to link | to teacher; |
| | to other device facilities (e.g. | Link to and use other device |
| | camera, accelerometer, etc.) | facilities such as camera or |
| | Start/stop activity or activities, set | accelerometer. |
| | timers, stop timers; | |
| | Send activity or activities to class, | |
| | retrieve student work, view | |
| | student work in progress, direct | |
| | activity or activities to | |
| | individuals, segments, combos, | |
| | or groups of students; | |
| | Choose information to be | |
| | displayed on public class | |
| | display; | |
| | Aggregate, view, display, or allow | |
| | viewing of selected categories | |
| | of student work; | |
| | Controls and permissions for | |
| | access to wide area networking | |
| | (e.g. internet) of student | |
| | computers through classroom | |
| | wireless access point; | |
| | Controls and permissions for | |
| | connection to other networked | |
| | classrooms over a wide area | |
| | network for communication, | |
| | competitions and games. | |
| Graphics | Access to presentation graphics | Individual computer graphics. |
| | including animation and video | May also include animation |
| | on public display (e.g. overhead | and video (e.g. for |
| | projector), and teacher's private | simulations, participatory |
| | display, of subject content, | simulations, games, |
| | activity materials, student work | competitions). |
| | including individual and | |
| | aggregations of groups segments | |
| | or combos. | |
| Communications | Management and monitoring of | Connection to teacher's |
| | active communications links in | computer, and other students |
| | the classroom. | with appropriate |
| | | permissions. Also, |
| | | connection to attached |
| | | peripherals (e.g., sensors) to |
| | | collect/import activity- |
| | | specific data. |
| Analysis | Aggregation algorithms, sorting, | May include a variety of |
| | scoring, computer algebra | specialized analyses (e.g. |
| | systems (CAS), text voice | CAS, game and competition |
| | analysis and interpretation, | game scoring from local |
| | dynamically linked multiple | perspective, speech |
| | representations for mathematics | recognition, movement |
| | and science. | analysis, dynamically linked |
| | | multiple representations for |
| | | mathematics and science). |

This table is presented by way of example only, it being understood by those skilled in the art having reference to this specification that many variations and alternatives in the relative API capabilities of the teacher and student versions of code segments are available to embodiments of this invention, while remaining within the scope of the invention as claimed herein. As noted above, and according to this embodiment of the invention, scripts 25 are generally activity-specific, in that each instance of a script 25 will be associated with a particular classroom activity, such as a problem set, quiz, lecture with interactive student responses, and the like. The same script 25 may be associated with multiple activities, realized as individual instances of that script 25 for each of those activities. For example, as mentioned above, the same script 25 may be used for multiple instances of the same activity with different content (e.g., lectures with interactive student responses on different subjects or different substantive material).

In general, it is contemplated that the writing and modifying of scripts 25 to control and automate the communication of data and messages in connection with classroom activities can be readily performed by a wide range of users and personnel. As noted above, scripts 25 are contemplated to be relatively simple executable programs, written in an interpreted scripting language (or by way of a “macro” function within an application), and as such can be written and modified without requiring a high level of programming knowledge or experience. As such, according to this architecture, the system manufacturer need not be involved in the writing and implementation of a new script 25. Rather, it is contemplated that teacher T, another educational professional, members of a “users' group”, or another user of software package 20 will generate some if not all of scripts 25 that will reside in user script pool 22. Some scripts 25 may be produced by the manufacturer of package 20, as shown in FIG. 3a by script 25A (in both of its teacher and student versions) residing in user script pool 22 of software package 20 as initially installed at teacher workstation TW.

FIG. 3b illustrates the architecture of software package 20 after use and further development following its initial installation. At this stage, user script pool 22 now includes new scripts 25B, 25C (each having both of their teacher and student versions), both of which were incorporated after initial installation of software package 20. As noted above, these new scripts 25B, 25C may have been prepared by educational personnel, and need not have been programmed and verified by the system manufacturer.

At this stage of the implementation, according to this embodiment of the invention, documents 28A through 28D have been prepared and are stored in system memory 14 of teacher workstation TW. Documents 28 pertain to individual activities to be carried out between teacher T and students S in a classroom environment. Examples of documents 28 include interactive lecture materials to be displayed in the class and at student workstations SW, interactive sets of questions or problems to be answered or worked by students S, quizzes and tests, interactive experiments, and the like. In this embodiment of the invention, scripts 25 can be embedded within individual documents 28, such that documents 28 serve as “carriers” of scripts 25. For example, an instance of script 25A (both its teacher and student versions) is embedded within document 28A, and an instance of script 25C (both its teacher and student versions) is embedded within document 28D. In this example, scripts 25 are instantiated when embedded into documents 28, such that scripts 25A, 25C also remain in user script pool 22, and can be instantiated again for embedding into other documents 28 as desired.

FIG. 3c illustrates the architecture of software package 20 at teacher workstation TW after startup and log-in of one or more student workstations SW into the networked classroom system. As the stage shown in FIG. 3c, document 28D has been opened by teacher workstation TW for use in a current class session. As such, the teacher version of script 25C is recognized and activated by base application 21 running at teacher workstation TW, and one or more “sockets” 29 to one or more of plug-ins 24A through 24C is opened to teacher workstation 21. Sockets 29 refer to communication ports or the like by way of which executable programs communicate with one another, in this case according to the API links that are included in the teacher version of script 25C.

Also at this stage, an instance of document 28D has been communicated to one or more student workstations SW via network interface 16. These communicated copies of document 28D each include S-script 25C (i.e., the student version of script 25C), but not the corresponding T-script 25C. Document 28D will then be opened at each student workstation SW as appropriate. Either immediately upon opening of document 28D at student workstation SW, or upon its student S activating the portion of document 28D containing script 25C, the API links included within S-script 25C are activated, opening one or more sockets 29 to one or more of plug-ins 24A through 24C as appropriate for the activity.

FIG. 3d generically illustrates the classroom environment for the case in which each of student workstations SW1 through SW4 (of FIG. 1) has opened document 28D and are working on its content. As shown in FIG. 3d, student workstations SW1 through SW4 have activated the student version of script (i.e., the S-script) 25C, while teacher workstation TW has activated the teacher version of script (i.e., the T-script) 25C. As a result, students S and teacher T can interactively work on document 28D, with base application 21 and its plug-ins 24 carrying out the necessary operations in that regard; software applications at student workstations SW cooperate to display the content of document 28D and to receive student responses when and where applicable.

According to embodiments of this invention, the separation of activity-specific scripts 25 from the non-activity-specific helper functions (e.g., plug-ins 24) in the architecture of software package 20 provides important benefits and advantages. This separation allows scripts 25 to be written and modified to accomplish new educational goals and functions without requiring plug-ins 24 to be modified and thus without adversely affecting the stability and reliability of the overall system. Plug-ins 24 can therefore be securely protected from user modification, while allowing education professionals, including teachers and administration personnel, to develop new classroom contexts and activities. The resulting system thus provides a reliable platform for new classroom contexts, including new and innovative approaches to the introduction and successful acquiring of content by classes of varying ability. As a result, embodiments of this invention foster and encourage innovative classroom activities that individualize content and evaluation based on students' progress, increasing the excitement and motivation of students in the classroom environment.

To provide additional context and description of the construction and operation of embodiments of this invention, examples of interactive classroom contexts encouraged by this invention will now be described in detail.

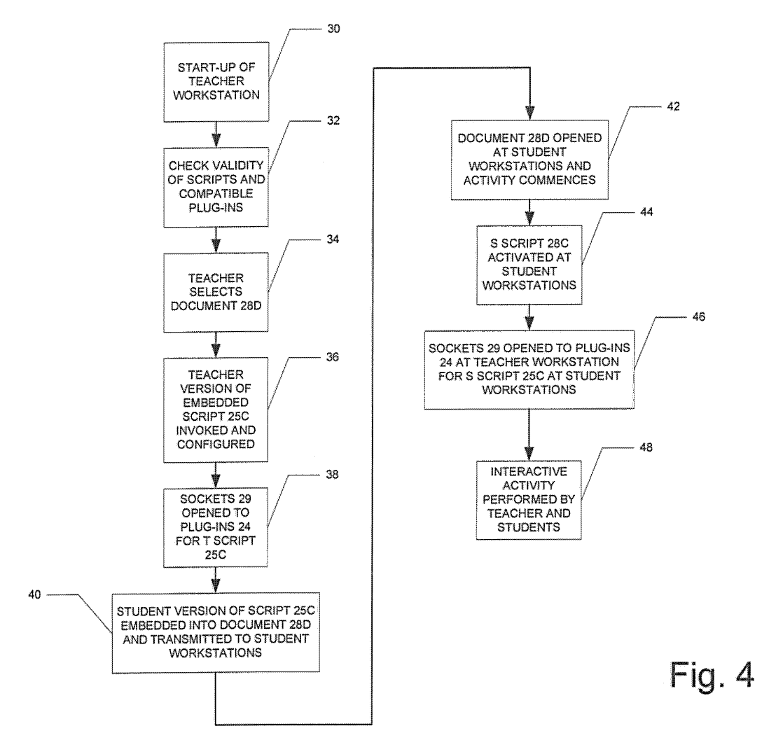

FIG. 4 illustrates the operation of an interactive networked educational system, constructed as described above, in initiating a classroom activity according to embodiments of this invention. This description will refer to the interactive networked educational system described above relative to FIGS. 1 through 3d, although it is to be understood that similar operations may be performed in systems implemented according to architectures different from that described, such as those described below relative to FIGS. 9a, 9b, and 10. In this example, start-up of teacher workstation TW and base application 21 is performed in process 30, which may include a log-in and verification to ensure that access to base application 21 is sought by an authorized person (i.e., a teacher or other authorized education professional). Following start-up process 30, process 32 is executed by base application 21 to check for the presence of scripts 25 in user script pool 22, and for the presence of valid plug-ins 24 to work with those scripts 25. Those scripts 25 that are valid in this regard are then allowed to add to and modify base application 21, for example to provide a teacher interface to corresponding activities, for example in the form of menu items, control buttons, and the like.

In process 34 according to this example, teacher T selects document 28D corresponding to an activity to be carried out in the classroom. In process 36, base application 21 then presents a menu item by way of which teacher T selects a script 25 to be used in connection with this document 28D. In the example of FIGS. 3b through 3d, this selected script is script 25C. Base application 21 invokes T-script 25C in process 36; if that selected T-script 25C requires configuration, teacher T provides the necessary configuration inputs, also in process 36. In process 38, upon the opening of document 28D by teacher T and the invoking of T-script 25C, base application 21 opens the appropriate sockets 29 to plug-ins 24 associated with that script 25C.

Fanning out of the activity to students S in the classroom environment is then accomplished in process 40, with the embedding of S-script 25C into document 28D, and the communicating of copies of document 28D with the embedded script 25C to student workstations SW via network interface 16 and over the corresponding network facility. In process 42, students S log in to the networked system at their student workstations SW, preferably with individualized identifiers and authentication to facilitate record-keeping by teacher T, and open the received document 28D to begin the activity. Upon a student S activating the portion of document 28D containing an embedded S-script 25C, or automatically if document 28D is of an “implicit” type (e.g., a “Quickpoll” document), student workstation SW activates that embedded S-script 25C in process 44. Upon activation of an instance of S-script 25C, process 46 is carried out at teacher workstation TW to open the appropriate sockets 29 to the corresponding plug-ins 24 to base application 21. These sockets 29 between S-scripts 25C and plug-ins 24 at teacher workstation 21 allow interactive execution of the classroom activity in process 48, involving student responses at student workstations SW and cooperative direction of the activity by teacher workstation TW.

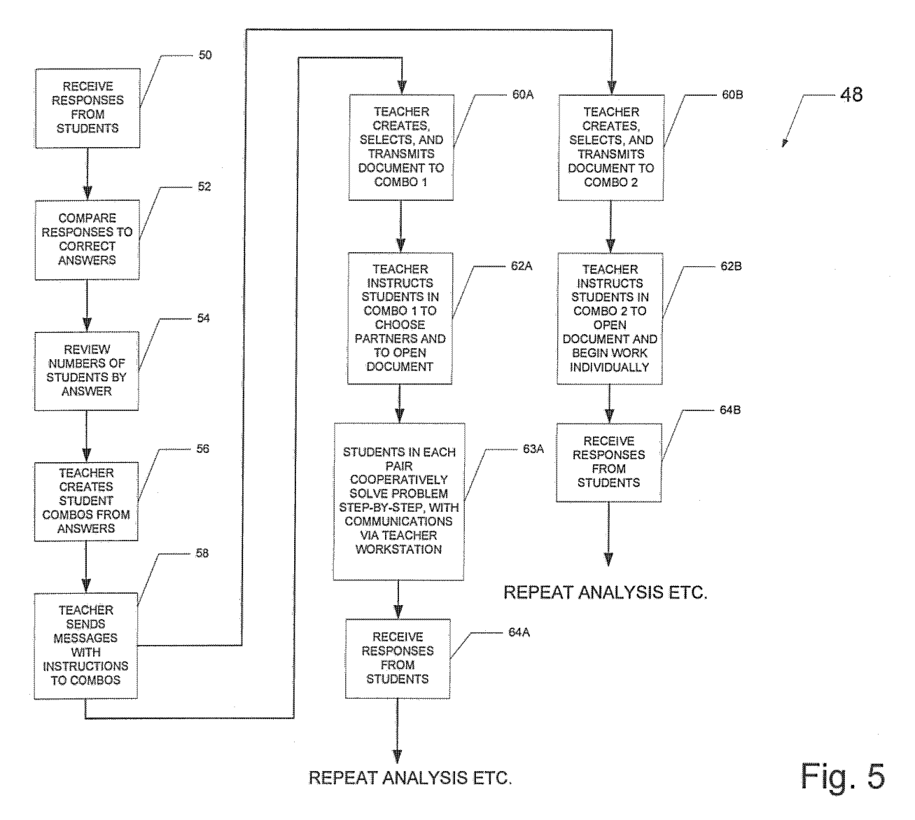

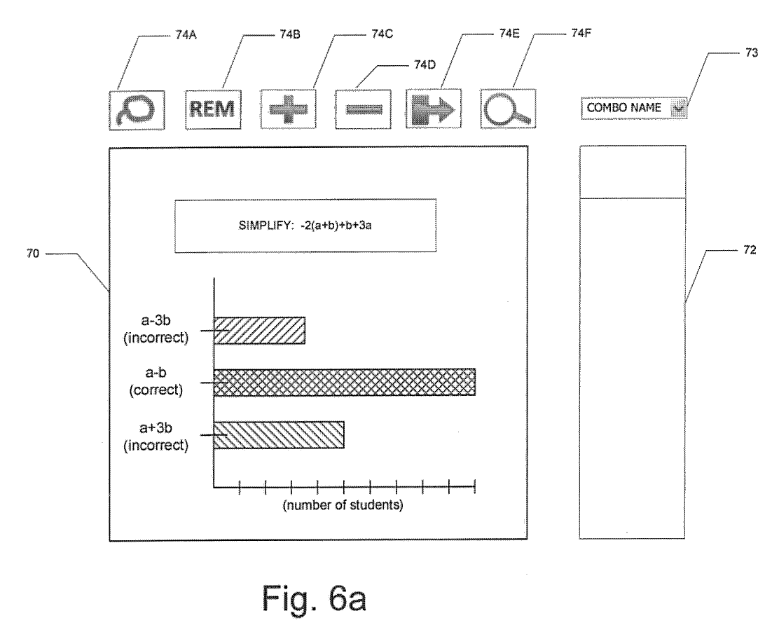

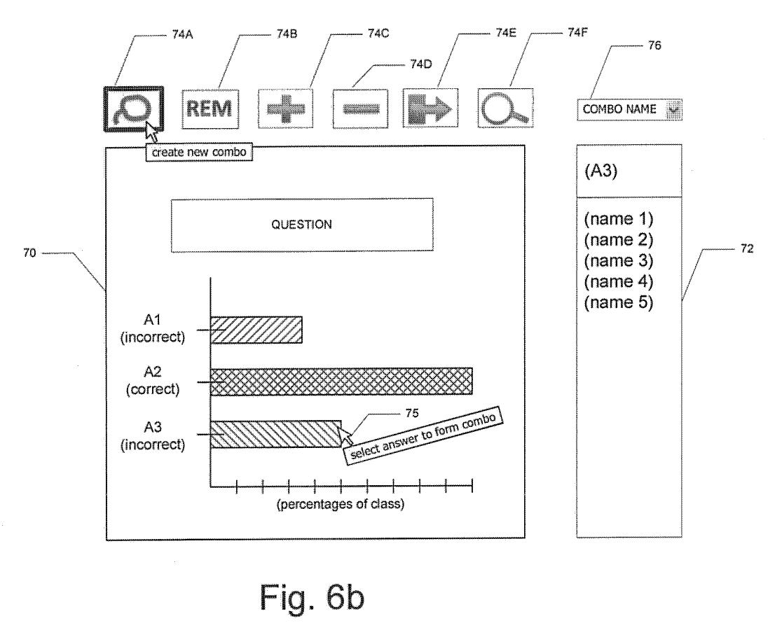

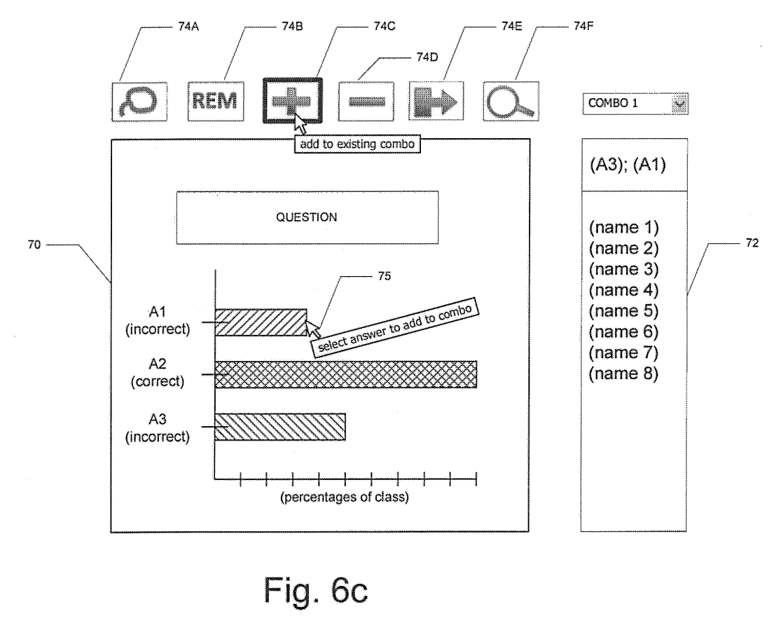

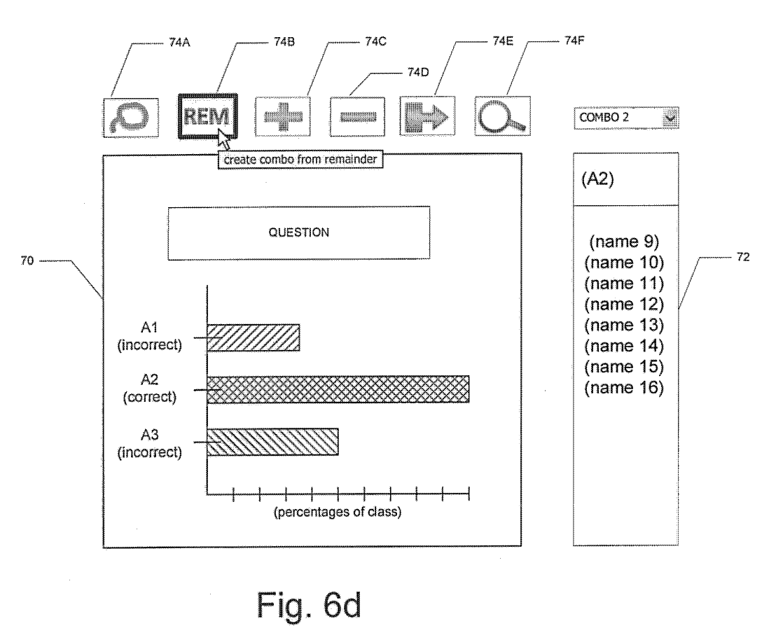

An example of an activity performed in process 48 will now be described with reference FIG. 5 in combination with FIGS. 6a through 6d. As stated above, embodiments of this invention provide the important advantage of allowing new and innovative ways in which students and the teacher can interact in an interactive classroom activity; accordingly, this particular example is to be understood as simply one example of many that are enabled by embodiments of this invention.

In process 50, teacher workstation TW receives responses from student workstations SW for the activity communicated in document 28D. According to embodiments of this invention, and according to the architecture described above, these responses were communicated from student workstations SW via instances of S-scripts 25C that include API links to open sockets 29 to one or more of plug-ins 24A through 24D. For purposes of this description, we will consider plug-in 24A as the destination helper function receiving and aggregating these responses, in which case each instance of S-script 25C executed at a student workstation SW communicates the responses from its corresponding student to teacher workstation TW via sockets 29 to plug-in 24A.

For purposes of this example, the activation of T-script 25C at start-up (process 30 of FIG. 4) makes certain functions available in the current window contexts of teacher workstation TW, including menu items and control buttons for dealing with “combos” of students, as will be described below. In process 52, teacher T controls T-script 25C (corresponding to S-script 25C embedded in the current document 28D) to access the student response data aggregated by that plug-in 24A, via sockets 29 opened by T-script 25C and accessible via the API links in that T-script 25C. T-script 25C may also have opened sockets to other plug-ins 24. For example, plug-in 24B may provide a “Review Workspace” plug-in to which T-script 25C can communicate according to its included API links via an open socket 29. In this example, this “Review Workspace” plug-in 24B carries out data processing, such as analysis of the aggregated student responses performed by teacher T in process 54 of FIG. 5. In this regard, plug-ins 24 are contemplated to be able to interact with other functions of base application 21, for example a Computer Algebra System (CAS) engine capable of evaluating student math process responses. It is contemplated that plug-ins 24 will typically have access to many more system resources of teacher workstation TW than will scripts 25.

In this example, teacher T plans to have those students who successfully answered a problem in document 28D work individually on new problems of greater difficulty, and to have those students who answered incorrectly to interactively work together in pairs on similar problems in order to gain the corresponding skill. In process 54, T-script 25C for this activity includes an executable function that causes plug-in 24B to display a histogram of responses from students to a specific problem in document 28D. FIG. 6a illustrates an example of a GUI screen displayed at a graphics display of teacher workstation TW in this regard. Main window 70 states the particular problem solved by students S, and provides a histogram of students responding with each of the correct answer and two incorrect answers. In this example, a plurality of the students answered the problem correctly, but subsets of the class answered incorrectly in two different ways.

As mentioned above, T-script 25C provided the context of menu items and control buttons for dealing with “combos” of students. In this regard, as shown in FIG. 6a, pane 72 is provided by way of which students S may be grouped into “combos”, i.e. subsets to whom new documents 28 can be transmitted, with pull-down list 73 provided to enable selection of specific ones of these combos. Control buttons 74A through 74F provide the capability of selecting particular functions pertinent to these combos. In this example, button 74A creates a new combo, button 74B creates a new combo from the “remainder” of students not previously members of a combo, button 74C adds a selected student or students to an existing combo, button 74D removes a student or students from an existing combo, button 74E initiates the sending of a message to a combo, and button 74F enables analysis of data pertaining to a combo.

The creation of combos for this class activity in process 56 continues with the selection of students based on their response to the problem, as shown in FIG. 6b. As shown in FIG. 6b, teacher T uses cursor 75 to select histogram bar A3 in window 70 (corresponding to those students S providing the same incorrect answer to the question also displayed above in window 70), and then clicks control button 74A to create the new combo. Following those GUI operations, names (“name 1” through “name 5”) of the students S corresponding to histogram bar A3 are displayed in pane 72, under display of the answer (A3) that they submitted. The name of this new combo can be entered in pulldown box 76 at this point.

If desired, additional students may be added to this newly-created combo in process 56. FIG. 6c illustrates the GUI operations carried out by teacher T in that regard. Teacher moves cursor 75 to select another histogram bar, in this case histogram bar A1 corresponding to those students S who provided the same incorrect answer to the question (but a different incorrect answer from answer A3), and then clicks control button 74C to add these students to the combo currently displayed in pane 72. As shown in FIG. 6c, “name 6” through “name”8″ have been added to this current combo (which has been named “COMBO 1”).

FIG. 6d illustrates another way in which teacher T can create combos according to this example implementation. Because “COMBO 1” has already been created, a one-click method for creating a new combo from the remainder of students S (i.e., those not yet assigned to a combo, which in this case are those students S who answered the question correctly) incorporated into T-script 25T allows teacher T to simply click REM control button 74B. In response, plug-in 24B places the remaining unassigned students S (“name 9” through “name 16”) into a new combo (“COMBO 2”) as shown in pane 72, along with the corresponding answer A2.

It is of course contemplated that various other operations for grouping students S in process 56, based on responses from classroom activities or otherwise, can be incorporated by those skilled in the art having reference to this specification. In process 58A of FIG. 5, teacher workstation TW transmits messages to students S in the various combos, such as assignment to a combo and instructions for proceeding from this point forward.

In this example, two combos (“COMBO 1” and “COMBO 2”) have been created, and will work in different ways from one another. In this example, COMBO 1 will interactively work in pairs to gain skill in the same context as the question that they missed, while COMBO 2 (those who answered the question correctly) will be given additional individual work to further enhance their skill in the subject matter.

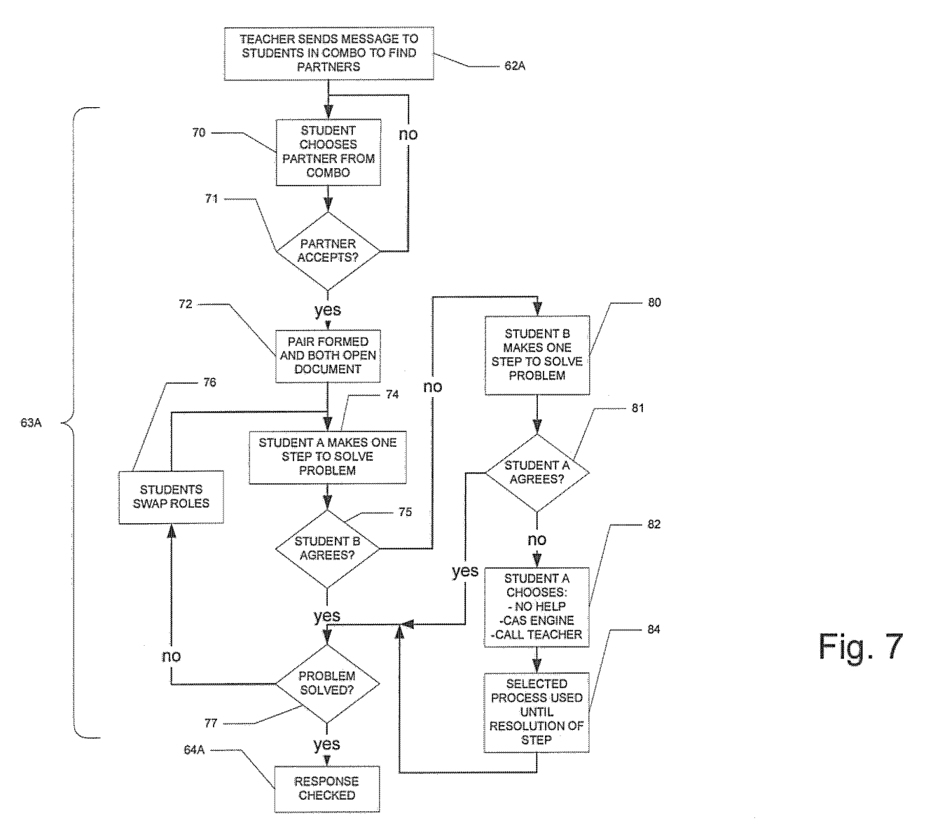

In process 60A, teacher T creates, selects, and transmits a new document 28 to students S in COMBO 1, in similar manner as described above relative to processes 34 through 40 of FIG. 4. This new document 28 will include one or more corresponding S-scripts 25 for carrying out collaborative work in the manner described below. Following transmission of this document 28, teacher T transmits messages to these same COMBO 1 students in process 62A, instructing them to choose partners and to open and begin work on the new document 28. The COMBO 1 students perform that work in process 63A, an example of which will be described with reference to FIG. 7.

According to this example implementation, the message sent by teacher T in process 62A advises each of the COMBO 1 students that he missed the question in the previous activity, and that he is now in COMBO 1; names of the other students in this COMBO 1 are also included in this message. Interactive solving process 63A begins in process 70 with one of the COMBO 1 students choosing a partner from the list of names in the message via S-script 25C, and that student's workstation SW transmitting a message to teacher workstation TW with that choice. According to embodiments of this invention, all communications among students S enabled by the corresponding S-script 25 are communicated to an appropriate communications plug-in 24 executing at teacher workstation TW, which will in turn manage the communication of messages to the recipients. If the selected student sends a message that she does not accept the invitation (decision 71 is “no”), the selecting student will make another selection in process 70 and the process repeats. Upon a partner accepting the invitation (decision 71 is “yes”), teacher workstation TW is notified, and the students in this pair both open document 28 that was transmitted by teacher workstation TW in process 62A, and begin work. In this embodiment, the paired students do not have to sit near one another, but can be across the room from one another or even in different rooms or locations.

In this example, the activity requested by teacher T is for the paired students to take turns with one another to solve a mathematics problem in a step-by-step fashion. As such, one student in the pair (“student A”) makes one step to solve the problem, in process 74, with that step communicated by S-script 25 to the other student in that pair (“student B”) by teacher workstation TW. In decision 75, student B decides whether she agrees with the step made by student A, and communicates that decision to student A via S-script 25 and teacher workstation TW.

If student B agrees with student A's step (decision 75 is “yes”), decision 77 is then performed at student workstations SW to determine whether the problem is complete. If the problem is not complete (decision 77 is “no”), students A and B swap roles in process 76 to take turns, and the process is repeated from process 74 and decision 75, with students A and B taking opposite roles.

At any point at which student B does not agree with the step taken by student A (decision 75 is “no”), control passes to process 80 in which student B makes one step to solve the current problem, and that step is transmitted to teacher workstation TW. In this event, student A is provided the opportunity to agree or disagree with student B's step, in decision 81. If student A agrees (decision 81 is “yes”), decision 77 is then performed as described above to determine whether the problem has been solved. If, on the other hand, student A does not agree with the step made by student B in process 80 (i.e., decision 81 is “no”), teacher workstation TW communicates a set of choices for proceeding further to student A. In this implementation, these choices include:
no help from outside of the group (i.e., students A and B will work out their differences);
invoke the Computer Algebra System (CAS) to provide assistance to student workstations SW, for example by suggesting the correct step; and
call teacher T to provide in-person assistance directly (or, for example, via an “expert student volunteer”, etc.)
   In process 84, the process selected by student A is then applied as appropriate, until resolution of the current solution step is attained, following which decision 77 determines whether the problem has been solved and the activity continues as described above.

The collaborative solution process engaged in by paired students A and B, in cooperation with teacher workstation TW, then continues until decision 77 determines that the problem is solved. In this event (decision 77 is “yes”), teacher workstation TW checks the response from students A and B in process 64A (FIG. 5) to determine whether the problem has been solved correctly and records that determination. If document 28 included more than one problem, and the activity is not complete, the process repeats from process 74 for the next problem in document 28.

Referring back to FIG. 5, the manner in which students S in COMBO 2 proceed can differ significantly from the approach taken by the students in COMBO 1. In this example, the COMBO 2 students are to work on new problems individually. As such, in this example, a new document 28 is created and transmitted by teacher workstation to student workstations SW assigned to the COMBO 2 students, in process 60B. T-script 25 executed by teacher workstation 21 transmits a message to the COMBO 2 students in process 62B, indicating their group membership in COMBO 2 if appropriate, and including instructions regarding the new document 28 that was transmitted in process 60B. In this case, the students in COMBO 2 are intended to work individually on the problems included in the new document 28 transmitted to COMBO 2, which is performed by these COMBO 2 students in process 63B. Upon completion of the asked-for solutions, student workstations SW transmit the student responses in process 64B to teacher workstation TW, for recording and continued analysis by teacher T at teacher workstation TW. Of course, if the current activity includes more than one problem, then the students continue until all problems are solved, or this particular classroom activity is halted. The results from students S in all COMBOs are then recorded and analyzed, as desired by teacher T and using plug-ins 24 and base application 21 as desired.

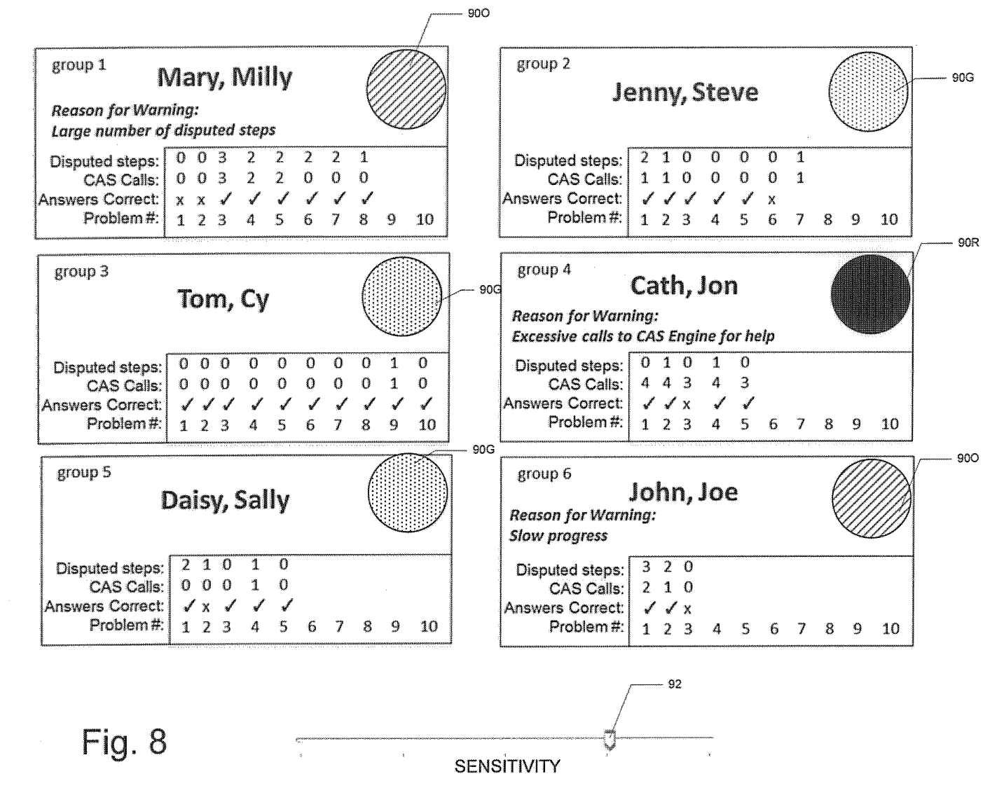

FIG. 8 illustrates an analysis approach provided by embodiments of this invention, for example by way of a T-script 25 directed to a “monitor group” function executed by one of plug-ins 24 at teacher workstation TW. In this example, T-script 25 associated with the current document 28 is invoked, such that each student response communicated to one of plug-ins 24 by S-scripts 25 in the collaborative work of process 63A for COMBO 1 is shown in a graphical view, an example of which is shown in FIG. 8 for six pairs of students in COMBO 1. In this example, document 28 transmitted in process 60A to the COMBO 1 students included ten possible problems to be solved by the pairs of students. This plug-in 24 performs an analysis of the response according to various pre-configured criteria, including whether a solution is right or wrong, and the extent to which steps taken by the pairs were “disputed” (e.g., steps in which one student in the pair disagreed with a step made by her partner), the number of calls to the Computer Algebra System (CAS), and the like. The detailed results are shown in FIG. 8 for each pair, by question.

Also according to this example, the analysis made by plug-in 24 applies a rule set or other heuristic to provide a red/orange/green light indication for each group, which is useful as a quick indication of which pairs of students had particular difficulty, and the reason for that indication. In this example, the results of group 4 (“Cath, Jon”) are shown with “red light” indicator 90R, along with the stated reason for that indicator of “Excessive calls to CAS Engine for help”, as determined the heuristic applied by plug-in 24. “Orange light” indicators 90O are shown for group 1 (“Mary, Milly”) because of “Large number of disputed steps”, and for group 6 (“John, Joe”) because of “Slow progress”. Groups 2, 3, and 5 of FIG. 8 all received “green light” indicators 90G. Plug-in 24 in combination with T-script 25 provides an additional configuration function by way of slider 92, allowing teacher T to select the sensitivity of the heuristic applied by plug-in 24 in assigning the red/orange/green light indicators 90.

Other tools for teacher T to analyze and manage the activity are also contemplated. For example, a T-script 25 may be provided by way of which teacher T can select one of the problems for one of the groups, for example by clicking on the display of FIG. 8. A corresponding plug-in 24 may then display the step-by-step discussion between the pairs of students in solving a disputed problem or one in which the CAS engine was called; these discussions can be readily accessed by teacher workstation 21 because student-to-student communications pass through and are managed by teacher workstation 21. These discussions may be in the form of “instant message” written communications, or in the form of voice recordings if student workstations SW are so equipped. Access to these discussions can provide teacher T with insight into which of the students in a given pair is having more difficulty with the material, into the particular troublesome concept for the class, and the like.

These examples are intended to exhibit the various programmable elements executed by teacher and student workstations cooperate to provide an interactive educational context to the classroom environment. According to embodiments of the invention, documents serve as carriers or containers for the executable code segments that have both student and teacher versions. These code segments serve as the “front-end” to the class activity, setting up and configuring the activity and the available functions to their respective users, and providing the manner in which communications are carried out with the appropriate helper functions to the base application. As such, it is contemplated that these code segments will be easy for educational professionals to program, test, and verify. Helper functions, on the other hand, support a powerful set of APIs because of their intended function in the middle and back ends of the processing flow, for example in collecting, aggregating, analyzing, and displaying data at teacher workstation, and controlling the operation of the activity during run time. As such, it is contemplated that the helper functions will be programmed and verified by the system manufacturer, perhaps requiring a “certificate of authentication” in order to execute.

FIGS. 9a and 9b illustrate the architecture of software package 100 and its operation, respectively, according to another embodiment of the invention, as installed and operating at teacher workstation TW. This architecture is contemplated to be especially suitable for modern smartphones and tablet computers, such as those operating under the iOS and ANDROID mobile operating systems. However, it is further contemplated that those skilled in the art having reference to this specification will recognize that this architecture may alternatively be applied to other types of workstations and architectures, including in a platform-independent manner.

In the architecture shown in FIG. 9a, software package 100 includes classroom networking application 101 (“T-App”) that is installed and operating on teacher workstation TW. As suggested in FIG. 9a, a corresponding version (“S-App”) of classroom networking application 101 is also installed and operating at each student workstations SW. T-App 101 serves the role of base application 21 in the architecture of FIGS. 3a through 3d, and as such includes program instructions executable at teacher workstation TW to perform operations useful to the teacher in delivering instructional material and corresponding classwork in the classroom environment. As such, T-App 101 includes the necessary tools for creating or accessing questions and problems to be solved by the class; workspace functions enabling teacher T for creating, displaying, and communicating lecture presentation material; interactive mathematical tools; and the like. In this regard, T-App 101 serves as a “shell” application for the presentation and analysis of the classroom activities to be carried out by the interactive networked system; accordingly, T-App 101 serves the function of base application 21 in the embodiments of the invention described above relative to FIGS. 3a through 3d. Conversely, the S-App versions installed at student workstations SW provide a “shell” application for each student, by way of which the students can view and respond to those classroom activities. According to embodiments of this invention, both of the T-App and S-App versions of classroom networking application 101 are contemplated to be programmed and verified by the manufacturer of software package 100, and as such neither is readily modifiable by education professionals or others outside of that system manufacturer.

In this embodiment of the invention, the user-programmable code segments that control and automate specific classroom activities are in the form of “applets” 105, in combination with which T-App 101 will operate. Applets 105 correspond to user programmable or configurable executable files that are written for a runtime environment, typically as a simple program for interpreting and automating the execution of certain tasks, such as a sequence of steps taken by a human user of the computer. Applets are generally written in a language specified by the host program (e.g., T-App 101), such as Java or as “macros” generated via graphical user interface (GUI) user commands within that host program. As such, applets 105 correspond to and serve the same function as scripts 25 in the embodiments of the invention described above relative to FIGS. 3a through 3d. In this regard, the architecture shown in FIG. 9a includes applet pool 102, residing in a memory resource within or accessible to teacher workstation TW, which stores several applets 105A through 105C that can be invoked by teacher T in connection with T-App 101 and the activity to be carried out.

In this embodiment of this invention, applets 105 provide communication conduits, in the software sense, between student workstations SW and teacher workstation TW during classroom activities. In a similar fashion as scripts 25 described above, applets 105 carry out communication between student workstations SW and teacher workstation TW and T-App 101, by way of application programming interface (API) links included in those applets 105 for providing that communication functionality. The particular API links that are included within an instance of script 25 thus amount to the “rights” granted to the workstation executing that script.

According to embodiments of this invention, applets 105 are “paired” in the sense that each applet 105 has a teacher version (shown with a “T” indicator) and a student version (shown with an “S” indicator). Each teacher version of an applet 105 (referred to herein as “T-applet” 105) may use one or more specific software development kit (SDK) facilities specific to T-applets, as provided for applet software developers (including education professionals creating new educational contexts according to embodiments of this invention) by way of a set of APIs specified as T-applet APIs. Conversely, the student version of applet 105 (referred to herein as “S-applet” 105) may use one or more SDK facilities specific to S-applets, as provided by way of a set of APIs specified as S-applet APIs. The T-applet SDK facilities are different from the S-applet SDK facilities, but are closely related to one another to ensure data compatibility between the two, considering their inter-operation as will be described below. However, it is contemplated that the T-applet SDK facilities will be more extensive than the S-applet SDK facilities, providing different access “rights” in the classroom network context in similar fashion as the difference in API links provided for the student and teacher version of scripts 25 in the embodiment of FIGS. 3a through 3d. In other words, the S-applet SDK facilities will grant lesser rights to student workstations SW relative to software package 100 than those available to teacher workstation TW. It is contemplated that the T-applet SDK facilities for T-applet 105 may permit teacher T to add to or modify menu items of T-App 101, activate “sockets” or communication ports to S-applet 105, modify graphical representations, permit interaction with other portions of T-app 101 such as calls to a CAS engine, and the like, while the corresponding S-applet 105 is not permitted to execute these operations. An applet SDK may also provide facilities for the applet software developer to run compatibility checks between a T-applet and its corresponding S-applet, for example within a simulated T-app/S-app environment.

According to embodiments of this invention, applets 105 are generally activity-specific, in that each instance of an applet 105 will be associated with a particular classroom activity, such as a problem set, quiz, lecture with interactive student responses, competition, game, collaborative activity, participatory simulation, and the like.

As in the case of scripts 25 in connection with the architecture of FIGS. 3a through 3d, it is contemplated that the writing and modifying of applets 105 to control and automate the communication of data and messages in connection with classroom activities can be readily performed by a wide range of users and personnel, without requiring a high level of programming knowledge or experience to do so. As such, according to this architecture, the system manufacturer need not be involved in the writing and implementation of new applets 105, such that educational professionals and other users of software package 100 can generate some if not all of applets 105 that will reside in user applet pool 102. Of course, some applets 105 may be produced by the system manufacturer and provided with T-App 101 when originally installed.

As mentioned above, FIG. 9a illustrates the architecture of software package 100 at teacher workstation TW after startup and log-in of one or more student workstations SW into the networked classroom system. At this stage, an instance of S-applet 105X has been communicated to one or more student workstations SW via network interface 16. These instances of S-applet 105X (i.e., the student version of applet 105X) will be opened and executing within and in cooperation with S-App 101 at student workstations SW. The corresponding T-applet 105X is instantiated and running at teacher workstation TW, as shown in FIG. 9a. Upon a student S activating S-applet 105X at a student workstation SW, API links included within that S-applet 105X are activated, and one or more sockets 109 are opened for communication between that instance of S-applet 105X and its corresponding T-applet 105X running at teacher workstation TW. As described above, sockets 109 refer to communication ports or the like by way of which executable programs communicate with one another, in this case according to the API links that are included in both versions of applet 105X.

Referring now to FIG. 9b, the operation of the architecture of FIG. 9a according to this embodiment of the invention will be described. It is of course to be understood that many variations of this operation are also contemplated, according to alternative implementations and embodiments of this invention.

In process 110, teacher T starts up T-App 101 at teacher workstation TW, and students S log in and connect their respective student workstations SW to the classroom network. After start-up, teacher T selects and opens one of applets 105 associated with T-App 101, specifically the T-applet version of that applet 105, from applet pool 102 or another memory resource, in process 112. Process 112 may be implemented by way of a menu item and list of applets 105, or the like. It is contemplated that T-applet 105 may require configuration by teacher T at opening, in which case teacher T would input the appropriate configuration parameters, also in process 112. Upon opening and configuration, T-applet 105 begins running within T-App 101 at teacher workstation TW.

In process 114, teacher workstation TW transmits the corresponding S-applet 105 to each of student workstations SW that are connected to the classroom network, via the established network facility and communications link. Sockets 109 are opened by T-applet 105 in process 116, preparing for communication with corresponding S-applet 105 when invoked at student workstations SW. Meanwhile, S-applet 105 is received at each student workstation SW in the classroom network, and commences running within S-App 101 at those student workstations SW, in process 118.

Following start-up and the opening of sockets 109 in this manner, an interactive activity can then be performed by teacher T and students S over the classroom network, in much the same manner as described above relative to FIGS. 5 through 8, in process 120. During interactive process 120, sockets 109 opened by T-applet 105 at teacher workstation TW and corresponding instances of S-applet 105 at student workstations SW will enable data transmission between teacher workstation TW and student workstations SW, with the format, content, and structure of those communicated data controlled by the T-applet and S-applets 105. A wide range of innovative interactive classroom contexts, including those designed and programmed into applets 105 by educational personnel rather than the system manufacturer, are contemplated.

FIG. 10 illustrates a variation on the app-applet architecture of FIGS. 9a and 9b, according to an alternative embodiment of the invention. In this variation, applet 105G is provided in the form of a general purpose activity shell, for which additional information is required to specify and carry out the classroom activity. Activity file 125 in system memory 14 of, or otherwise accessible to, teacher workstation TW, includes that additional information, the form of content to be used in the classroom activity. For example, applet 105G (in both its T-applet and S-applet versions) can provide the shell functionality for an interactive game, perhaps as a math competition between student groups, and activity file 125 provides the set of math problems to be solved in that game.

In its operation, the architecture of FIG. 10 carries out similar operations as described above relative to FIG. 9b. Upon start-up, and following the selecting, configuring, and opening of T-applet 105G for the desired activity, teacher workstation TW sends the corresponding S-applet 105G to student workstations SW, for execution within S-App 101 at those locations. Activity file 125 for the classroom activity to be carried out is also communicated to student workstations SW over the network facility; alternatively, student workstations SW may operate to fetch activity file 125, upon opening and activating S-applet 105G. S-applet 105G includes the capability of reading the information contained within activity file 125, and cooperates with S-App 101 to structure and carry out the corresponding classroom activity, including communication of responses and messages between student workstations SW and teacher workstation TW as described above. The range and nature of the interactive operation of the classroom activity under this architecture are contemplated to be similar to that described above in connection with other embodiments of the invention, and as may be later developed by education personnel and others.

According to each of the embodiments of this invention, as described above, capability is provided by way of which education personnel, including teachers and administrative staff, can readily develop and program executable code for implementing new and innovative educational contexts within an interactive networked classroom system, without requiring a high level of programming skill or expertise, and without necessitating the involvement of the system manufacturer. The separation of activity-specific code segments from the non-activity-specific “apps”, helper functions, and the base application code, allows these code segments to be written and implemented without adversely affecting the stability and reliability of the overall system. As such, embodiments of this invention enable rapid and effective realization of contexts including new and innovative approaches to the introduction and successful acquiring of content by classes of varying ability. As a result, embodiments of this invention foster and encourage innovative classroom activities that individualize content and evaluation based on students' progress, increasing the excitement and motivation of students in the classroom environment.

While this invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A networked educational system, comprising:
a network facility;
a teacher workstation, comprising:
a processor;
a network interface for coupling to the network facility;
input/output resources; and
a memory resource for storing data and program instructions, the program instructions comprising:
a base application executable by the processor; and
one or more code segments, each code segment comprised of a teacher version and a student version, each version of each code segment comprising executable program instructions; and
one or more student workstations, comprising:
a processor;
a network interface coupled to the network facility;
input/output resources; and
a memory resource for storing data and program instructions;
wherein the base application includes program instructions that, when executed by the processor of the teacher workstation, causes the teacher workstation to transmit a student version of a first code segment to one or more student workstations via the network facility;
wherein the student version of the first code segment includes program instructions that, when executed by the processor of the student workstation, causes the student workstation to communicate student inputs received via its input/output resources to the teacher workstation via the network facility;
and wherein the teacher version of the first code segment includes program instructions that, when executed by the processor of the teacher workstation, causes the teacher workstation to access the received student inputs.

2. The system of claim 1, wherein each of the one or more code segments comprises executable instructions according to an interpreted scripting programming language.

3. The system of claim 1, wherein the program instructions stored in the memory resource of the teacher workstation further comprise a plurality of helper functions that, when executed by the processor, perform operations in cooperation with the base application and each of a plurality of code segments;
wherein the teacher and student version of the first code segment each include application programming interfaces (API) links by way of which, when executed, the teacher and student versions of the code segment communicate data with a helper function of the base application;
and wherein the API links for the teacher version of the first code segment differs from the API links for the student version of the first code segment.

4. The system of claim 3, wherein the API links for the student version of the first code segment comprises one or more links for transmitting student inputs to a first helper function;
wherein the API links for the teacher version of the first code segment comprises one or more data access links to the first helper function for accessing received student inputs;
and wherein the one or more data access links in the API links for the teacher version of the first code segment are not included in the API links for the student version of the first code segment.

5. The system of claim 3, wherein a second helper function aggregates student input data;
wherein the API links for the teacher version of the first code segment comprises one or more data links to the second helper function, by way of which the teacher workstation can access the aggregated student input data;
and wherein the one or more data links to the second helper function are not included in the API links for the student version of the first code segment.

6. The system of claim 3, wherein the API links for the student version of the first code segment comprises one or more links for transmitting student-to-student communications to a first helper function;
wherein the API links for the teacher version of the first code segment comprises one or more data access links to the first helper function for accessing received student-to-student communications;
and wherein the teacher version of the first code segment includes program instructions that, when executed by the processor of the teacher workstation, causes the teacher workstation to forward the student-to-student communications to intended recipients.

7. The system of claim 6, wherein the teacher version of the first code segment includes program instructions that, when executed by the processor of the teacher workstation, causes the teacher workstation to arrange selected students into groups.

8. The system of claim 3, wherein the helper functions comprise plug-ins to the base application.

9. The system of claim 1, wherein data stored by the memory resource of the teacher workstation comprises:
a plurality of documents;
wherein each of the one or more code segments comprises a script;
wherein the base application includes program instructions that, when executed by the processor of the teacher workstation, causes the teacher workstation to:
embed a student version of a first script in a first document; and
transmit the first document with the embedded student version of the first script to one or more student workstations.

10. The system of claim 9, wherein the teacher version of the first script includes program instructions that, when executed by the processor of the teacher workstation, causes the teacher workstation to:
arrange selected students into a plurality of groups; and
transmit a document to each of a first and a second group, the documents transmitted to the first and second groups differing from one another.

11. The system of claim 1, wherein each of the one or more code segments comprises an applet comprised of a teacher version and a student version, each version of each applet comprising executable program instructions;
wherein the teacher and student versions of a first applet each includes software development kit (SDK) facilities providing access rights in the system;
and wherein the access rights of the teacher and student versions of the first applet differ from one another.

12. A method of performing an interactive classroom activity in a networked system of a teacher workstation and a plurality of student workstations, comprising:
at the teacher workstation, invoking a teacher version of a first code segment associated with the interactive classroom activity,
transmitting a student version of the first code segment from the teacher workstation to each of the plurality of student workstations;
opening a communication socket between the student version of the first code segment at each of the plurality of student workstations and the teacher workstation;
receiving student responses from one or more of the student workstations at the teacher workstation, via the communications socket; and
analyzing the received student responses at the teacher workstation.

13. The method of claim 12, further comprising:
at the teacher workstation, embedding the student version of the first code segment in a first document;
wherein the step of transmitting the student version of the first code segment comprises:
transmitting the first document with the embedded student version of the first code segment to each of the plurality of student workstations.

14. The method of claim 12, further comprising:
before the invoking step, checking the validity of each of the one or more code segment in a code segment library at the teacher workstations relative to one or more associated helper functions associated with a base application executing at the teacher workstation;
wherein the step of opening a communication socket comprises:
at the teacher workstation, opening a communication socket between the teacher version of the first code segment and an associated helper function; and
opening a communication socket between the student version of the first code segment at each of the plurality of student workstations and the associated helper function at the teacher workstation.

15. The method of claim 14, wherein each of the one or more code segments comprises executable instructions according to an interpreted scripting programming language;
and wherein each of the one or more associated helper functions comprises a plug-in to the base application.

16. The method of claim 12, wherein each of the one or more code segments comprises an applet having a teacher version and a student version;
and further comprising:
communicating contents of an activity file associated with a first applet from the teacher workstation to each of the plurality of student workstations.

17. A non-transitory computer-readable medium storing a computer program that, when executed on a teacher workstation, causes the teacher workstation to perform a sequence of operations for executing an interactive classroom activity with a plurality of student workstations, the sequence of operations comprising:
invoking a teacher version of a first code segment associated with the interactive classroom activity,
transmitting a student version of the first code segment to each of the plurality of student workstations;
opening a communication socket between the student version of the first code segment at each of the plurality of student workstations and the teacher workstation;
receiving student responses at the teacher workstation via the communications socket; and
analyzing the received student responses at the teacher workstation.

18. The medium of claim 17, wherein the sequence of operations further comprises:
embedding the student version of the first code segment in a first document;
wherein the operation of transmitting the student version of the first code segment comprises:
transmitting the first document with the embedded student version of the first code segment to each of the plurality of student workstations.

19. The medium of claim 17, wherein the sequence of operations further comprises:
before the invoking step, checking the validity of each of the one or more scripts in a code segment library relative to one or more associated helper functions;
wherein the operation of opening a communication socket comprises:
opening a communication socket between the teacher version of the first code segment and an associated helper function; and
opening a communication socket between the student version of the first code segment at each of the plurality of student workstations and the associated helper function.

20. The medium of claim 19, wherein each of the one or more code segments comprises a script programmed according to an interpreted scripting programming language;
and wherein each of the one or more associated helper functions comprises a plug-in to a base application.

21. The medium of claim 17, wherein each of the one or more code segments comprises an applet having a teacher version and a student version;
and wherein the sequence of operations further comprises:
communicating contents of an activity file associated with a first applet from the teacher workstation to each of the plurality of student workstations.
